(19) United States
(12) Patent Application Publication
(10) Pub. No.: US 2022/0260177 A1
(43) Pub. Date: Aug. 18, 2022

(54) Diagnostic System for a Valve that can be Actuated by a Control Pressure

(71) Applicant: Siemens Aktiengesellschaft, Muenchen (DE)

(72) Inventor: Simon WEILANDT, Karlsruhe (DE)

(21) Appl. No.: 17/630,561

(22) PCT Filed: Jul. 28, 2020
(86) PCT No.: PCT/EP2020/071297

§ 371 Date: Jan. 27, 2022

(30) Foreign Application Priority Data
Jul. 29, 2019 (DE) 10 2019 211 213.7

(51) Int. Cl. F16K 37/00; F16K 17/00

(52) U.S. Cl. CPC F16K 37/0041; F16K 17/003

(57) ABSTRACT

A diagnostic system for a valve that can be actuated by a control pressure includes a pressure sensor measuring the control pressure, a position sensor detecting the valve position, and an artificial neural network configured to describe a valve signature in the form of the control pressure-valve position correlation over the entire control range of the valve and to update the position correlation during the ongoing operation of the valve based on the measured control pressure and the detected valve position.

### CROSS-REFERENCE TO RELATED APPLICATIONS

This is a U.S. national stage of application No. PCT/EP2020/071297 filed 28 Jul. 2020. Priority is claimed on European Application No. 10 2019 211 213.7 filed 29 Jul. 2019, the content of which is incorporated herein by reference in its entirety.

### BACKGROUND OF THE INVENTION

### 1. Field of the Invention

The invention relates to a diagnostic system for a valve that can be actuated via a control pressure.

### 2. Description of the Related Art

Valves in the process engineering industry are often controlled with the aid of pneumatic actuators. With an electropneumatic positioner, a pneumatic control pressure for actuating the valve can be generated dependent upon a measured valve position (actual position) in order thereby to move the valve into a predetermined target position and to hold it there.

US 2016/0071004 A1 discloses a method for predictive servicing of a control valve that is incorporated in an industrial plant. Here, a plurality of parameters of the control valve are monitored as defined by Development and Application of Methods for Actuator Diagnosis in Industrial Control Systems (DAMADICS). In order to recognize an error, a plurality of “neuro-fuzzy” networks that compare at least one simulated value with a sensor value are utilized.

European application EP 3 421 851 A1 discloses a vacuum valve with a pressure sensor that can be configured as a vacuum sliding valve, a shuttle valve or a mono-valve and is typically suitable for regulating a mass flow rate or a volume flow rate. The vacuum valve comprises a valve opening and a valve closure that is coupled to a pneumatic or electropneumatic drive unit.

US 2013/0110418 A1 discloses a diagnostic method for a control valve, where the position of the control valve is measured. Pressure data that represents a pressure difference over the valve actuator is also detected. The pressure data can also provide the movement direction of the valve actuator. Position data of the valve position and pressure data is processed to determine data regarding the start point for valve actuations under normal conditions. A valve characteristic that provides a relationship between position data and pressure data is determined therefrom.

US 2015/0276086 A1 discloses a method for performing diagnostics on a valve, which has an actuator with an actuator stem. In this method, a plurality of positions of the actuator rod that are subdivided into two categories are determined. The categories correspond to positions of the actuator stem during an opening movement of the valve and during a closing movement of the valve. The valve characteristic is then determined from this data.

During operation, the functional capability of the valve is impaired by wear and contamination. Typical functional disturbances to the valve are, for example, a leak in the valve in the closed state and the catching or jamming of the valve in the end positions.

Errors occurring during operation can lead to a failure of the process engineering system in which the valve is installed. A continuous or regular diagnosis of the valve enables errors in the valve and its drive to be recognized or predicted early and, through timely maintenance measures or an exchange of the valve, damage in the system to be prevented.

It is known to diagnose error conditions of a valve via a “valve signature”. The valve signature is the control pressure-valve position dependency (pressure-distance characteristic line) over the entire positioning path of the valve. For this purpose, when the intact valve is put into service with an electropneumatic positioner in the context of an initialization run, the control pressure is recorded as dependent upon the valve position and is stored as a starting or reference signature. Later, during the operation of the valve in the system, a new, then current valve signature is acquired and compared with the starting signature. Based on the comparison that can be performed automatically via diagnostic software, error conditions can be recognized. However, the acquisition of the current valve signature must be instigated by a user and herein also, the entire operating range of the valve is passed through. For this purpose, the current process operation must be interrupted.

### SUMMARY OF THE INVENTION

In view of the foregoing it is an object of the invention to provide a diagnostic system for a valve that enables an automatic establishment of the current valve signature.

This and other objects and advantages are achieved in accordance with the invention by a diagnostic system for a valve that is actuatable via a control pressure, where the diagnostic system includes a pressure sensor that measures the control pressure, a position sensor that detects the valve position and an artificial neural network that is configured to construct the valve signature in the form of the control pressure-valve position dependency over the entire operating range of the valve and to update the dependency during operation of the valve based on the measured control pressure and the detected valve position.

The neural network pre-trained with the starting signature is trained with the measured values of the control pressure obtained during ongoing operation of the valve and the associated valve position and can therefore provide the current valve signature as an estimate.

In accordance with the invention, the neural network is configured to obtain the detected control pressure as an input variable, to generate the valve position as an output variable and configured to be trained dependent upon a deviation between the output variable (estimated value) and the detected valve position (actual value). At any desired point in time, the control pressure can then be fed to the neural network trained in this way as a calculated value rather than as a measured value, where on corresponding variation of the control pressure, the neural network outputs the valve position over the entire operating range and thereby the current valve signature.

Alternatively, the measured valve position can be fed to the neural network as an input variable to obtain the control pressure as an output variable. The neural network is then trained dependent upon a deviation between the output control pressure and the actually measured control pressure.

In accordance with invention, the valve behavior can also be temperature-dependent. As a result, a temperature sensor measuring the temperature of the valve or its surroundings is provided and the neural network is configured to obtain the measured temperature as an additional input variable.

As a result of static friction and sliding friction, the valve signature typically shows hysteresis, so that the neural network can preferably be configured to obtain the current direction of change (direction of action) of the valve position as an additional input variable.

Alternatively, the neural network can consist of two partial networks for the two different directions of change of the valve position.

For a valve diagnosis, the current valve signature is compared with the starting signature of the intact valve. For this purpose, the diagnostic system can have a memory store for storing the starting signature and an evaluating device which, through a comparison of the current valve signature constructed by the neural network with the stored starting signature, makes and outputs a diagnostic statement regarding the valve.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described below using exemplary embodiments and making reference to the figures of the drawing, in which:

FIG. 1 shows a valve with an actuator, a positioner and a diagnostic system in accordance with the invention;

FIG. 2 shows a graphical plot of a valve signature;

FIG. 3 shows a neural network as a component of the diagnostic system in accordance with the invention; and

FIG. 4 shows an embodiment of the neural network consisting of two partial networks in accordance with the invention.

### DETAILED DESCRIPTION OF THE EXEMPLARY EMBODIMENTS

The same reference characters have the same meaning in the different figures. The illustrations are purely schematic and do not show any size relationships.

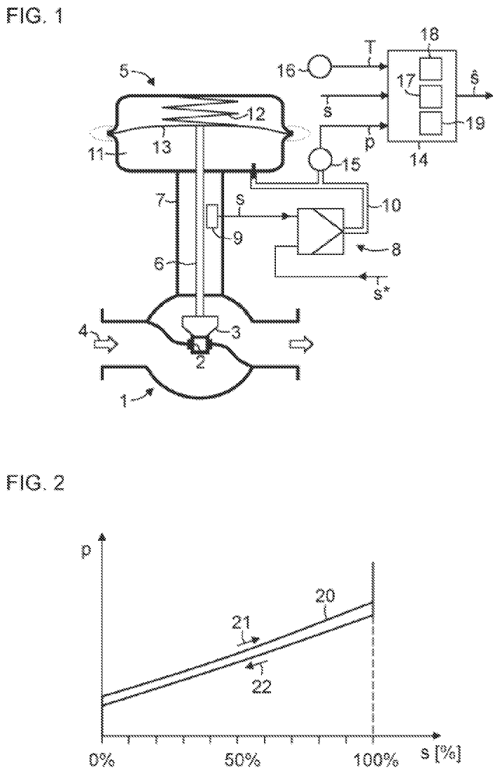

FIG. 1 shows a valve (e.g., a globe valve) 1 which, via a corresponding stroke of a closing element 3 cooperating with a valve seat 2, controls the passage of a medium 4. The stroke is generated by a pneumatic drive 5 and is transmitted via a valve stem 6 to the closing element 3. The drive 5 is connected via a yoke 7 to the housing of the valve 1. Mounted on the yoke 7 is an electropneumatic positioner 8 that detects the valve position s at the input side via a position sensor 9 engaging with the valve stem 6, compares this detects the valve position s with a target value s* fed via a data interface from a field bus and controls the pneumatic drive 5 via a compressed air output 10 in the context of a correction of the system deviation.

The pneumatic drive 5 shown here is a single-acting diaphragm drive with spring return and a drive chamber 11. The drive chamber 11 is fed with or bled of air by the positioner 8 so that a control pressure p is generated therein, which acts against the force of a spring 12 on a diaphragm 13 connected to the valve stem 6. Alternatively, a double-acting drive can be used in conjunction with a double-acting positioner that generates two counteracting control pressures on the two sides of the diaphragm 13. Furthermore, in place of a membrane drive, a pivot drive can be provided if, in place of a linear stroke movement, a rotary movement is to be generated for the valve (e.g., a ball valve or flap valve).

A diagnostic unit 14 obtains, as input signals, the valve position s detected by the position sensor 9, the control pressure p measured by a pressure sensor 15 and the temperature T measured by a temperature sensor 16 on the drive 5. As described further below, the diagnostic unit 14 determines a current signature of the valve 1 from the input signals fed via a neural network 17. A starting signature of the intact valve 1 is stored in a memory store 18. An evaluating device 19 serves to compare a currently determined valve signature with the starting signature and, based on typical deviations, to diagnose errors such as wear, breakage of the return spring 12 and/or non-sealing closing of the valve 1.

FIG. 2 shows an example of the valve signature 20 in the form of the control pressure p during feeding 21 and bleeding 22 of the pneumatic drive 5 dependent upon the valve position s. The value s=0% represents the completely closed valve 1 and the value s=100% represents the open valve 1.

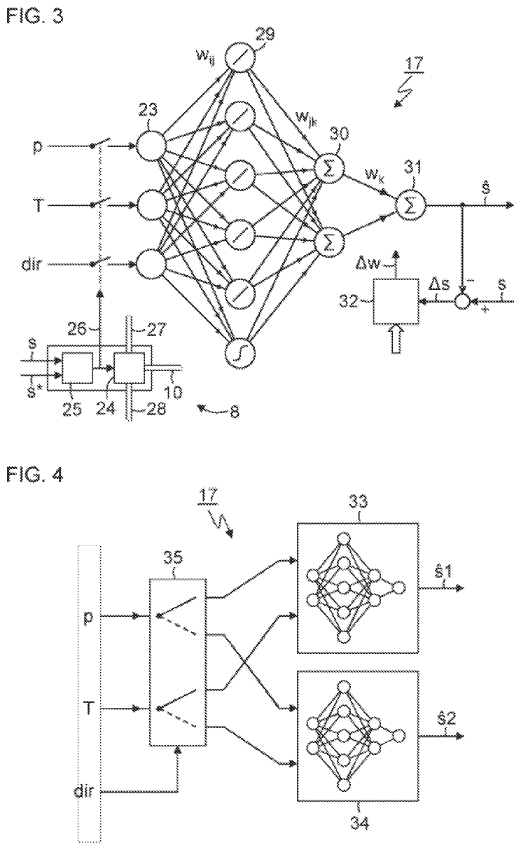

FIG. 3 shows an example of the neural network 17 that obtains the detected control pressure p, the measured temperature T and the current direction of action dir as input variables and generates an estimated value ŝ for the valve position s as an output variable. The direction of action dir states in which of the two directions the valve 1 is currently being actuated and whether the pneumatic drive 5 is currently being fed or bled. The neural network 17 was pre-trained with the starting signature of the intact valve 1.

The neural network 17 shown is a feed-forward regression network that has an input layer with an input element 23 for each of the input variables p, T, dir. The input variables p, T, dir are fed to the neural network 17 only when the valve 1 is at rest and not being moved. The positioner 8 can contain, for example, a piezo valve unit 24 that converts control signals 26 obtained by a controller 25 dependent upon the target-actual comparison s*-s into pneumatic positioning increments, where compressed air present at a supply air connection 27 is dosed into the drive chamber 11 or it is bled via a venting connection 28. The input variables p, T, dir can thus be fed to the neural network 17 in the pauses between the control signals 20. Two hidden layers each consisting of a plurality of neurons 29 or 30 are arranged downstream of the input layer. The input variables p, T, dir are provided in each neuron 29 of the first hidden layer with individual weighting factors wᵢⱼ and are summed to a response of the relevant neuron 29. The responses of the neurons 29 of the first hidden layer are provided in each neuron 30 of the second hidden layer with individual weighting factors wᵢⱼ and are summed to a response of the relevant neuron 30. An output element 31 that sums the responses of the neurons 30, each with an individual weighting factor wⱼₖ, to the estimated value ŝ for the valve position is arranged downstream of the second hidden layer. In order to adapt the neural network 17 to changes in the valve behavior and to learn the relationship that is to be reproduced between the control pressure p and the valve position s (valve signature), the weighting factors w=wᵢⱼ, wⱼₖ, wₖ of the neural network 17 are changed with the aid of adaptation algorithms 32 in the context of a reduction of the error Δs=s−ŝ between the estimated value ŝ of the valve position supplied by the neural network 17 and the measured valve position s.

In order to be able to estimate the trustworthiness of the learned signature 20, the frequencies of the valve positions s visited can be determined. If, for example, the valve 1 is mostly moved between s=70% and s=90%, then the learned signature 20 in this region is more trustworthy than outside thereof. Occasionally, however, e.g., on initialization, the valve 1 is always also moved over the full positioning path.

In the example shown in FIG. 4, the neural network 17 consists of partial networks 33, 34 for the two different directions of change dir of the valve position s. Dependent upon the direction of change dir, the input variables p, T are fed via a switchover device 35 to either one or the other of the two partial networks 33, 34 that supply the different estimates ŝ1, ŝ2 of the valve position s for the two directions of change dir.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-6. (canceled)

7. A diagnostic system for a valve which is actuatable via a control pressure, the diagnostic system comprising:
a pressure sensor which measures the control pressure;
a position sensor which detects the valve position and an artificial neural network in a diagnostic unit which is configured to construct a valve signature comprising a control pressure-valve position dependency over an entire operating range of the valve and configured to update said control pressure-valve position dependency during operation of the valve based on the measured control pressure and the detected valve position; and
a temperature sensor which measures a temperature of the valve;
wherein the artificial neural network is configured to obtain the detected control pressure as an input variable, to generate an estimated value of the valve position as an output variable and is configured to be trained, dependent upon a deviation between the output variable and the detected valve position and at least one of (i) the measured temperature of the valve and (ii) surroundings of the temperature sensor; and
wherein the artificial neural network is configured to obtain the measured temperature as an additional input variable.

8. The diagnostic system as claimed in claim 7, wherein the neural network is further configured to obtain a direction of change of the valve position as an additional input variable.

9. The diagnostic system as claimed in claim 7, wherein the neural network consists of two partial networks which are configured to construct and update a valve signature for different directions of change of the valve position.

10. The diagnostic system as claimed claim 7, further comprising:
a memory store for storing a valve signature acquired with an intact valve; and
an evaluating device which configured to, through a comparison of the current valve signature constructed by the neural network with the stored valve signature, make and output a diagnostic prediction regarding the valve.
